(19) United States
(12) Patent Application Publication
(10) Pub. No.: US 2007/0211319 A1
(43) Pub. Date: Sep. 13, 2007

(54) DISPLAY APPARATUS, HOLOGRAM REPRODUCTION APPARATUS AND APPARATUS UTILIZING HOLOGRAM

(75) Inventor: Yoshinori Tomida, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/683,493

(22) Filed: Mar. 8, 2007

(30) Foreign Application Priority Data
Mar. 9, 2006 (JP) 2006-064236
Aug. 25, 2006 (JP) 2006-229234

(51) Int. Cl. G03H 1/02

(52) U.S. Cl. 359/3; 359/27; 359/15

(57) ABSTRACT

The invention is to provide a novel display apparatus. The display apparatus includes a display device including a layer constructed by including an alkali halide or an alkali earth halide of which optical characteristics are changed by a laser light irradiation of a first wavelength region equal to or larger than 190 nm but less than 380 nm; a first light source for emitting a laser light of the first wavelength region, in order to write display data in the display device; and a second light source for irradiating the display device in which the display data are written, with a light of a second wavelength region of from 380 to 800 nm.

### BACKGROUND OF THE INVENTION

1. Field of the Invention

The present invention relates to a display apparatus, a hologram reproduction apparatus and an apparatus utilizing a hologram. The present invention further relates to a hologram reproduction apparatus usable as a three-dimensional (hereinafter represented as 3D) stereo display.

2. Description of the Related Art

As a display utilizing alkali halide, a cathode chromic accumulation tube, called a dark trace tube, is known. In the dark trace tube, a colored image formed by an electron beam is observed directly.

Also Japanese Patent Application Laid-open No. 2000-206858 discloses a hologram reproduction apparatus utilizing an electron beam.

### SUMMARY OF THE INVENTION

In case of utilizing an electron beam, the interior of a display device for forming the holographic interference fringes has to be made as a vacuum system.

Also an alkali halide or an alkali earth halide is an electrically insulating material, so that an irradiation with an electron beam may cause an accumulation of a charge, so-called charge-up phenomenon, in the display device constructed with such material.

Therefore, the present invention provides a novel display apparatus, a novel hologram reproduction apparatus, and a novel apparatus utilizing a hologram, utilizing a laser light irradiation in a wavelength region equal to or larger than 190 nm but less than 380 nm.

A first aspect of the present invention provides a display apparatus including:

a display device containing a layer constructed by including an alkali halide or an alkali earth halide of which optical characteristics are changed by a laser light irradiation of a first wavelength region equal to or larger than 190 nm but less than 380 nm;

a first light source for emitting a laser light of the first wavelength region, in order to write display data in the display device; and

a second light source for irradiating the display device in which the display data are written, with a light of a second wavelength region of from 380 to 800 nm.

A second aspect of the present invention provides a hologram reproduction apparatus including:

a display device constructed by including an alkali halide or an alkali earth halide of which optical characteristics are changed by a laser light irradiation of a first wavelength region equal to or larger than 190 nm but less than 380 nm;

a writing unit which writes holographic interference fringes in the display device, by a laser light irradiation of the first wavelength region; and

a unit which irradiates the holographic interference fringes with a reading light of a second wavelength region of from 380 to 800 nm thereby reproducing a holographic stereo image.

The holographic interference fringes may be formed by writing dot data, based on holographic data, into the display device.

Also a stereo display and a non-stereo display can be switched by switching a pixel size formed by the dot data.

A third aspect of the present invention provides a hologram reproduction apparatus including:

a display device containing first, second and third laminated layers constructed by including an alkali halide or an alkali earth halide of which optical characteristics are changed by a laser light irradiation of a first wavelength region equal to or larger than 190 nm but less than 380 nm;

wherein the first, second and third layers have absorption peak wavelengths different with one another in a state where the optical characteristics are changed by the laser light irradiation of the first wavelength region;

wherein the absorption peak wavelengths of the first, second and third layers are respectively from 380 to 500 nm, from 500 to 600 nm and from 600 to 800 nm;

a writing unit for writing holographic interference fringes in the display device by the laser light irradiation of the first wavelength region; and

a reproduction unit for reproducing a holographic stereo image by irradiating the display device, in which the holographic interference fringes are written, with a reading light.

A fourth aspect of the present invention provides an apparatus utilizing a hologram including:

a volume hologram recording medium constructed by including an alkali halide or an alkali earth halide of which optical characteristics are changed by a laser light irradiation of a first wavelength region equal to or larger than 190 nm but less than 380 nm;

a first light source for irradiating the volume hologram recording medium with a laser light of the first wavelength region; and

a second light source for irradiating the volume hologram recording medium with a light of a second wavelength region of from 380 to 800 nm;

wherein the volume hologram recording medium and the first light source are moved in a relative three-dimensional scan to form, on the volume hologram recording medium, volume holographic interference fringes based on bit data.

It is also possible to construct the volume hologram recording medium with plural layers containing an alkali halide or an alkali earth halide, so as that the plural layers are changed in the optical characteristics by a laser light irradiation of the first wavelength region and have respectively different absorption peak wavelengths in a state where the optical characteristics are changed.

The present invention is directed to a display apparatus comprising:

a display device including a layer constructed by including an alkali halide or an alkali earth halide of which optical characteristics are changed by a laser light irradiation of a first wavelength region equal to or larger than 190 nm but less than 380 nm;

a first light source for emitting a laser light of the first wavelength region, in order to write display data in the display device; and

a second light source for irradiating the display device in which the display data are written, with a light of a second wavelength region of from 380 to 800 nm.

The display device can comprise the layer in plural units, containing materials having light absorption peak wavelengths which are different each other.

The first light source and the second light source can include a single light source variable in wavelength.

The display data can be holographic data.

The present invention is directed to a hologram reproduction apparatus comprising:

a display device constructed by including an alkali halide or an alkali earth halide of which optical characteristics are changed by a laser light irradiation of a first wavelength region equal to or larger than 190 nm but less than 380 nm;

a writing unit which writes holographic interference fringes in the display device, by a laser light irradiation of the first wavelength region; and

a unit which irradiates the holographic interference fringes with a reading light of a second wavelength region of from 380 to 800 nm thereby reproducing a holographic stereo image.

The holographic interference fringes are written as dot data based on holographic data in the display device.

The hologram reproduction apparatus further can comprises:

an erasing unit for erasing the holographic interference fringes;

wherein a continuous reproduction of holographic stereo images is executed by repeating the writing of the holographic interference fringes by the writing unit, the reproduction of the holographic stereo image by the reproduction unit, and the erasure of the holographic interference fringes by the erasing unit.

The erasing unit can erase the holographic interference fringes by an action of a laser light irradiation, an electromagnetic wave or a heat.

The laser light irradiation can have a wavelength equal to or larger than 700 nm.

The irradiation of the reading light of the second wavelength region can be executed from a same side as the laser light irradiation of the first wavelength region to the display device.

The writing unit can form the holographic interference fringes on an imaginary plane defined in a direction of depth of the display device.

In the hologram reproduction apparatus, a stereo display and a non-stereo display can be switched by switching a pixel size in the dot data.

The present invention is directed to a hologram reproduction apparatus comprising:

a display device containing first, second and third laminated layers constructed by including an alkali halide or an alkali earth halide of which optical characteristics are changed by a laser light irradiation of a first wavelength region equal to or larger than 190 nm but less than 380 nm;

wherein the first, second and third layers have absorption peak wavelengths different with one another in a state where the optical characteristics are changed by the laser light irradiation of the first wavelength region;

wherein the absorption peak wavelengths of the first, second and third layers are respectively from 380 to 500 nm, from 500 to 600 nm and from 600 to 800 nm;

a writing unit for writing holographic interference fringes in the display device by the laser light irradiation of the first wavelength region; and

a reproduction unit for reproducing a holographic stereo image by irradiating the display device, in which the holographic interference fringes are written, with a reading light.

In the hologram reproduction apparatus, the holographic interference fringes can be written as dot data based on holographic data in the display device.

In the hologram reproduction apparatus, three reading lights respectively having a peak wavelength, selected within a second wavelength region of from 380 to 800 nm, of from 380 to 500 nm, a peak wavelength of from 500 to 600 nm and a peak wavelength of from 600 to 800 nm are used on the display device in which the holographic interference fringes are written, to reproduce a holographic stereo image.

The hologram reproduction apparatus further can comprising:

an erasing unit for erasing the holographic interference fringes;

wherein a continuous reproduction of holographic stereo images is executed by repeating the writing of the holographic interference fringes by the writing unit, the reproduction of the holographic stereo image by the reproduction unit, and the erasure of the holographic interference fringes by the erasing unit.

The erasing unit can erase the holographic interference fringes by an action of a laser light irradiation, an electromagnetic wave or a heat.

The laser light irradiation can have a wavelength equal to or larger than 700 nm.

In the hologram reproduction apparatus, a stereo display and a non-stereo display can be switched by switching a pixel size in the dot data.

The present invention is directed to an apparatus utilizing a hologram comprising:

a volume hologram recording medium constructed by including an alkali halide or an alkali earth halide of which optical characteristics are changed by a laser light irradiation of a first wavelength region equal to or larger than 190 nm but less than 380 nm;

a first light source for irradiating the volume hologram recording medium with a laser light of the first wavelength region; and

a second light source for irradiating the volume hologram recording medium with a light of a second wavelength region of from 380 to 800 nm;

wherein the volume hologram recording medium and the first light source are moved in a relative three-dimensional scan to form, on the volume hologram recording medium, volume holographic interference fringes based on bit data.

The volume hologram recording medium can include plural layers containing an alkali halide or an alkali earth halide, and the plural layers are changed in the optical characteristics by a laser light irradiation of the first wavelength region and have respectively different absorption peak wavelengths in a state where the optical characteristics are changed.

Thus, the present invention provides a novel display apparatus, a novel hologram reproduction apparatus and a novel apparatus utilizing a hologram.

Further features of the present invention will become apparent from the following description of exemplary embodiments with reference to the attached drawings.

### BRIEF DESCRIPTION OF THE DRAWINGS

FIG. 1 is a schematic view illustrating the present invention.

FIG. 2 is a schematic view illustrating a mode for displaying holographic interference fringes in the apparatus illustrated in FIG. 1.

FIG. 3 is a schematic view illustrating a mode of hologram reproduction in the apparatus illustrated in FIG. 1.

FIGS. 4A and 4B are views illustrating a coloring principle, respectively in structure and in energy, of a substance having a color center, to be employed in a display surface in the apparatus illustrated in FIG. 1.

FIG. 5 is a schematic view illustrating a mode for displaying volume hologram interference fringes in the volume hologram reproduction of the present invention.

FIG. 6 is a graph, illustrating transmission spectra in comparative manner before and after an ultraviolet laser light irradiation, of potassium bromide employed in a display surface in Example 1 of the present invention.

FIG. 7 is a graph, illustrating a transmission spectrum after an ultraviolet laser light irradiation, of NaBr employed in the display surface in Example 5 of the present invention.

FIG. 8 is a graph, illustrating transmission spectra after an electron beam irradiation, of rubidium chloride, potassium chloride and potassium fluoride, employed in a display surface in Example 7 of the present invention.

FIG. 9 is a schematic view illustrating a mode of forming a color center, utilizing a two-beam interfered exposure of a prior technology.

FIG. 10 is a view, illustrating reflective spectra after an ultraviolet laser light irradiation, of rubidium chloride, sodium bromide and potassium fluoride, employed in a volume hologram reproduction of the present invention.

FIG. 11 is a schematic view illustrating a display apparatus of an exemplary embodiment.

### DESCRIPTION OF THE EMBODIMENTS

At first, there will be explained how the present invention has been made.

As a result of intensive investigations undertaken by the present inventor, it is recognized that a material containing an alkali halide or an alkali earth halide shows a change in optical characteristics, when subjected to an irradiation with a laser light of a first wavelength region of from 190 to 380 nm (as the wavelength region is in an ultraviolet region, such laser may hereinafter be called as “ultraviolet laser”), and that a changed state of such material is relatively stable.

It is also recognized that a novel display apparatus and a novel hologram reproduction apparatus of high usefulness can be realized by utilizing a fact that the alkali halide or alkali earth halide is reversible with respect to the change in the optical characteristics, and the present invention has thus been made.

### First Exemplary Embodiment: Display Apparatus

A display apparatus of the present embodiment (FIG. 11) has following characteristics.

Firstly, it is equipped with a display device 1190, containing a layer constructed by including an alkali halide or an alkali earth halide of which optical characteristics are changed by an irradiation with a laser light 1192 of a first wavelength region equal to or larger than 190 nm but less than 380 nm.

With respect to the materials constituting such layer, applicable is a content of description in subsequent exemplary embodiments.

The display apparatus of the present embodiment is constructed by further including a first light source 1191 for emitting a laser light 1192 of the first wavelength region, in order to write display data in the display device; and

a second light source (not illustrated) for irradiating the display device in which the display data are written, with a light of a second wavelength region of from 380 to 800 nm.

With respect to the first and second light sources, application is a content of description in subsequent exemplary embodiments.

The second light source is not illustrated in FIG. 11, but it may be provided in a same side as the first light source with respect to the display device 1190, or in an opposite side.

The display device in the present exemplary embodiment includes at least following two concepts.

a. First Concept

This is a case where an image or a character data is written, by the first light source, into the display device constructed by including a specified material such as an alkali halide, and the light of the second wavelength region is introduced into the device whereby the display device is used as a filter.

In such case, whether the incident light is transmitted or not transmitted changes depending on whether it is a position where the data is written or not by the first light source. Utilizing such phenomenon, the display device can be used as a light modulating device for displaying a non-stereo image, as in a liquid crystal display.

The display device of the present invention, described above in a case of utilizing transmission of incident light (used as so-called transmission type display apparatus), may also be utilized as a reflective display device.

b. Second Concept

This is a case where a reading light is introduced into the display device, thereby realizing a stereo image display.

Subsequent exemplary embodiments describe in detail utilization of a hologram particularly for displaying a stereo image, but the present invention is not limited to a display apparatus utilizing a hologram.

### Second Exemplary Embodiment: Hologram Reproduction Apparatus

Now a hologram reproduction apparatus will be described.

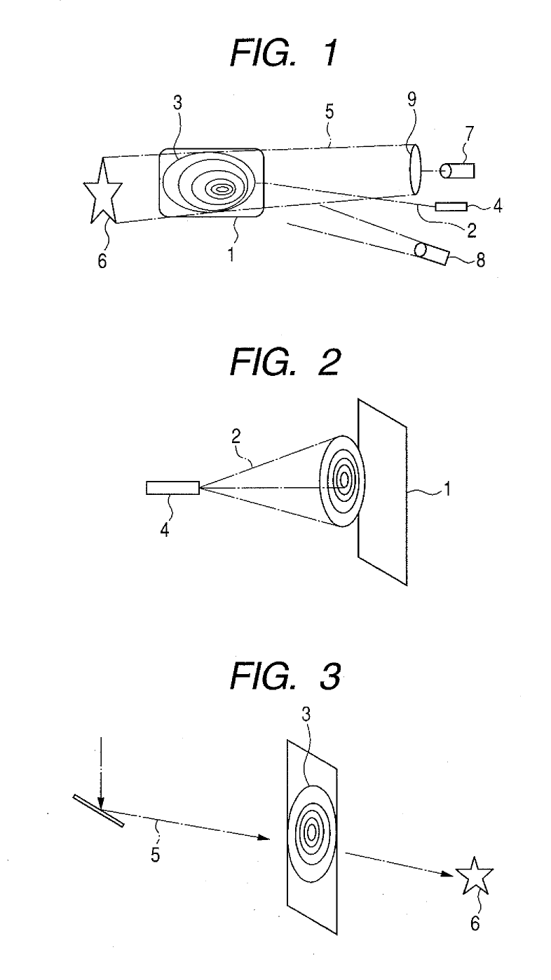

FIG. 1 illustrates a display surface 1 of a display device constructed by including an alkali halide or an alkali earth halide, of which optical characteristics are changed by an irradiation of a laser light 2 of a first wavelength region equal to or larger than 190 nm but less than 380 nm.

Illustrated also is an ultraviolet laser light irradiation unit 4 for the irradiation with the laser light 2 of the first wavelength region. The ultraviolet laser light irradiation unit 4 may be a gas laser such as an excimer laser or a solid-state laser utilizing a semiconductor.

Holographic interference fringes 3 are written into the display device, by the irradiation with the laser light 2 of the first wavelength region.

The holographic interference fringes 3 are irradiated with a reading light 5 of a second wavelength region of from 380 to 800 nm, thereby reproducing a holographic stereo image. The reading light 5, for example a visible laser light in the aforementioned wavelength region, irradiates the holographic interference fringes 3, for example through a magnifying lens 9 which is employed when necessary.

Thus a reproduced stereo image 6 of hologram is obtained as illustrated in FIG. 1.

The holographic interference fringes may be written as dot data in the display device by the ultraviolet laser light irradiation unit 4, based on holographic data entered from the exterior (or entered in advance).

Naturally the hologram reproduction apparatus may be equipped with an erasing unit for erasing the holographic interference fringes.

A continuous reproduction of holographic stereo images may be achieved by repeating a writing step for the holographic interference fringes by the writing unit, a reproduction step for the holographic stereo image by the reproduction unit, and an erasing step for the holographic interference fringes by the erasing unit.

The erasure is not particularly restricted in the method thereof, and may be executed by subjecting the display device to a laser light irradiation, an electromagnetic wave or a heat.

In case of erasure by the laser light irradiation, employed is a laser light source of a wavelength of 700 nm or longer.

The laser light source for writing, that for reproduction and that of erasure may be realized by a single light source in case of a variable light source.

As illustrated in FIG. 1, the irradiation of the reading light 5 of the second wavelength region may be executed from a same side, with respect to the display device, as the laser light irradiation of the first wavelength region.

Also the writing unit 4 can form the holographic interference fringes on an imaginary plane, which is defined in a direction of depth in the display device.

Also a stereo display and a non-stereo display can be switched by switching a pixel size written by the dot data (details being described later).

In the following, exemplary embodiments for executing the present invention will be described in detail, with reference to the attached drawings.

FIG. 1 illustrates the structure of an exemplary embodiment of the hologram reproduction apparatus of the present invention. A volume hologram reproduction of the present invention will be described later.

In the drawing, illustrated is a display surface 1 of which optical characteristics are changed by an ultraviolet laser light irradiation. An ultraviolet laser light irradiation unit 4 condenses an ultraviolet laser light 2 onto the display surface 1 under a two-dimensional scan and under a luminance modulation according to digital holographic data, thereby writing the holographic interference fringes 3 necessary for the stereo image reproduction. A method of preparation of the digital holographic data will be described later.

A reading light irradiation unit irradiates the holographic interference fringes 3, written in the display surface 1, with a reading light 5 of a second wavelength region of from 380 to 800 nm, thereby obtaining a reproduced stereo image 6 of the hologram. The display surface 1 is constructed by utilizing an alkali halide or an alkali earth halide.

The reading light irradiation unit includes a visible light laser 7, and a magnifying lens 9 for enlarging a visible laser light therefrom thereby irradiating the display surface 1. The reading light irradiation unit may utilize a white-colored light in order to apply a modification to the hologram.

The ultraviolet laser light 2 has a wavelength of 380 nm or less, which is below the wavelengths visible to human, and preferably 360 nm or less that is defined as the ultraviolet region in the international unit system (SI). On the other hand, a wavelength region of 190 nm or less is known as a vacuum ultraviolet region which involves a large absorption loss by the air and requires a lens system of a special material because of the wavelength-refractive index relationship, thereby becoming unable to exploit the advantages of the laser light over an electron beam.

In the present invention, therefore, an ultraviolet wavelength region of from 190 to 360 nm is employed advantageously. For example employable is a third harmonic YAG laser (355 nm), a fourth harmonic YAG laser (266 nm) or a pulsed laser such as a KrF excimer laser (248 nm), or an ArF excimer laser (193 nm). Also employable is a semiconductor laser or a planar light-emission laser of ultraviolet wavelength region, which is currently under development.

A laser is utilized because of a high energy density, and a high converging property of the beam required for hologram recording. The ultraviolet laser light irradiation unit 4 includes, for example, a lens for condensing the ultraviolet laser light, an ultraviolet mirror for defining an irradiating position of the ultraviolet laser light, and a galvano mirror or a polygon mirror for executing a scan by the ultraviolet laser light. An erasing unit 8 may be provided, if necessary, for erasing the interference fringes 3 written on the display surface 1.

Now the digital holographic data above will be described. It is described in Japanese Patent Application Laid-open No. 2000-206858 (Patent Document 2), proposed earlier by the present inventor. The digital holographic data is prepared in advance by a following method. As in an ordinary hologram recording, an object is irradiated with a coherent (interferable) light (wave) and a scattered, reflected or transmitted light is made to interfere with a reference light.

A laser light or an electron beam is generally employed as such wave. As it is required, for the purpose of the present invention, to record the interference pattern as a binary or multi-value electric signal, an image pickup device is used for recording the interference pattern. The recording may be executed by directly capturing the interference fringes or by capturing an image thereof focused on a diffusing plate. Otherwise the interference fringes formed as a density pattern on a photosensitive material may be read.

Since the ordinary image pickup device has a density of several tens of microns per pixel while the interference pattern ordinarily has a density of several microns or less, the interference fringes are projected under magnification, for example by a magnifying lens, and recorded. Also instead of utilizing an actual object, employable also is data called CG hologram, prepared by calculating the interference fringes utilizing a computer graphic technology.

FIG. 2 illustrates a mode of displaying holographic interference fringes. As illustrated in FIG. 2, the display surface 1 is irradiated with the ultraviolet laser light 2 from the ultraviolet light irradiation unit 4 to form a dot-shaped color center in the alkali halide constituting the display surface 1. The ultraviolet laser light 2 is luminance modulated by the ultraviolet laser irradiation unit 4, under a two-dimensional scan, according to the bit data for digital hologram, thereby constructing holographic interference fringes 3 formed by a group of dots.

FIG. 3 illustrates a mode of hologram reproduction. As illustrated in FIG. 3, the reading light 5 is diffracted and made to interfere by the holographic interference fringes 3 thereby forming a reproduced stereo image 6 of the hologram. Also a continuous reproduction of holographic stereo images is achieved by returning the holographic interference fringes 3 to a ground state by a laser light irradiation or a heating by the erasing unit 8, and repeating the display of the holographic interference fringes or the reproduction of the reproduced stereo holographic image. Naturally a color display may be executed in a similar manner.

The digital hologram displaying surface 1 of the present invention utilizes a material including, as an alkali halide or an alkali earth halide, a combination of following cations and following anions.

The cation is at least one of lithium, sodium, potassium, rubidium, cesium, francium, beryllium, magnesium, calcium, strontium, barium, and radium. It may be employed as a salt combined with an anion, which is at least one of fluorine, chlorine, bromine, iodine, and astatine.

Also a mixture including plural cations and plural anions above may also be utilized. Further, a perhalogenic acid salt, formed by a combination of a perchlorate anion or a perbromate anion and an alkali cation or an alkali earth cation, is also usable. Hereinafter, these are collectively called a substance having a color center.

The substance having a color center, lacking an optical absorption in the visible wavelength region, is colorless and transparent in a single crystal state. The substance having a color center becomes colored in a portion irradiated with the ultraviolet laser light, and at the same time shows a change in the refractive index in a specified wavelength range.

The reading light (generally a coherent laser light, and called a reproducing visible laser light) is characterized in including the wavelength of such coloration and the wavelength range of change in the refractive index. On the other hand, a portion not irradiated by the ultraviolet laser light does not show an absorption nor a change in the refractive index in the visible region, thus being transparent or white-colored and exhibiting a high transmittance or a high reflectance to the laser light. The reproduced holographic stereo image can be obtained by utilizing this property as a diffraction filter for the reproducing visible laser light and by utilizing the holographic interference fringes 3 of an appropriate form.

The substance having a color center is considered to generate an exciton (pair of an electron and a positive hole) upon being irradiated by an ultraviolet laser light, and the electron is trapped in a trapping level to form a color center.

The color center is described in “Hikari-bussei Handbook” (pages 228, 398).

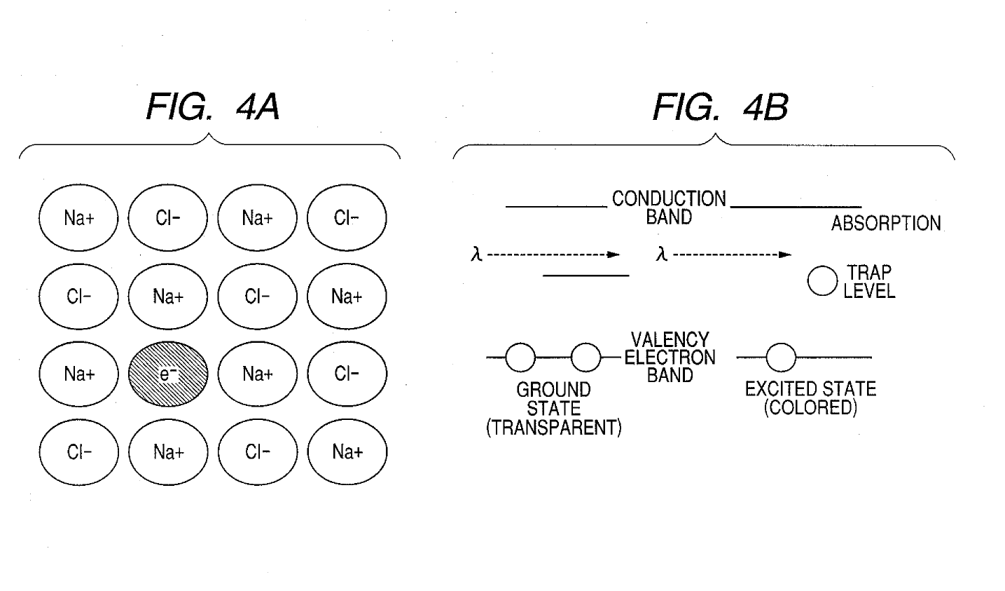

FIGS. 4A and 4B are views illustrating the coloring principle of the substance having a color center, respectively in structure and in energy.

The coloring mechanism is considered to be based, as illustrated in FIG. 4A, on a fact that an electron is trapped in an empty lattice point of halogen in an ionic crystal.

In terms of energy, a trap level exists between a conduction band and a valence band as illustrated in FIG. 4B, and an electron is excited from the valence band to the trap level by an electromagnetic wave such as an ultraviolet laser light (hereinafter, such excitation being called a primary excitation, and a state where an electron is excited to the trap level being called an excited state) The electron in such trap level is characterized in having a relatively long lifetime at a temperature in the vicinity of the room temperature.

Then the trapped electron is re-excited from the trap level to the conduction band by a visible (laser) light or by heat (such excitation being hereinafter called a secondary excitation), and the color is extinguished simultaneously as the electron returns from the conduction band to the valence band.

Such coloring phenomenon is applied to a dark trace tube utilizing an electron beam. In the dark trace tube, an electron beam irradiates an alkali halide to cause a coloration, which is observed directly. In the dark trace tube, the electron beam has a large spot size, as the colored portion is observed directly.

In contrast, in the invention of the present exemplary embodiment, an ultraviolet laser light is used for forming the color center.

Also the display surface does not display an image to be directly observed but displays the holographic interference fringes. Therefore the ultraviolet laser spot has a smaller size, and an image formation is executed by the action, on the display surface, not only of the ultraviolet laser light but also of the reading light and the erasing light or the heat.

Also in ordinary fluorescent materials, an excitation from the valence band which is a ground level to the conduction band or the trap level which is an excitation level is possible by an ultraviolet laser light, but the lifetime at the excitation level is usually short in the vicinity of the room temperature.

Also the ordinary fluorescent materials are intended to utilize an emitted fluorescence, and do not cause a change of the color thereof nor is used like a filter even when a color change occurs.

In the ordinary phosphorescent materials, the electrons are released by thermal motion and diffusion from the excitation level and return to the ground level while emitting a fluorescence, and the excitation (florescence) has a short lifetime.

The display surface of the present invention has a thermally stable excitated state, and is characterized in maintaining a colored state until the action of the ultraviolet laser light and the reproducing visible laser light (and further the erasing light) is executed over a frame.

The present invention employs an alkali halide or an alkali earth halide which is colorless and transparent or white-colored in the ground state.

In the present invention, as described above, a substance having a color center such as an alkali halide or an alkali earth halide is colored in a portion irradiated by the ultraviolet laser light, thus exhibiting a low transmittance or a low reflectivity to the reproducing visible laser light at the wavelength of coloration, together with a change in the refractive index. On the other hand, a portion not irradiated by the ultraviolet laser light does not have an absorption in the visible region, thus being transparent or white-colored and exhibiting a high transmittance or a high reflectivity to the laser light, without a change in the refractive index. These facts are utilized to construct a filter or a spatial light modulator (SLM) for the reproducing visible laser light, combined with holographic interference fringes of an appropriate form, thereby enabling a reproduction of a holographic stereo image.

The absorption in the visible wavelength region, in the excited state by the ultraviolet laser light, is considered to be caused by a (re)excitation from the trap level to the valence band by the light of a wavelength, corresponding to an energy gap between the trap level and the valence band. The display surface of the present invention, containing the substance having the color center, functions as a filter for the reproducing visible laser light, and, by displaying holographic interference fringes of an appropriate form, causes a diffraction and an interference of the reproducing visible laser light thereby executing a hologram reproduction.

Also a reading light irradiation unit which emits reading lights of three wavelengths of R, G and B may be used. Also employed is an ultraviolet laser light irradiation unit capable of writing plural holographic interference fringes, involving changes in spectral absorption respectively corresponding to the reading lights of three colors and/or involving a change in the refractive index in a specified wavelength region and/or involving a difference in the pitch of the holographic interference fringes. In this manner it is possible to simultaneously reproduce hologram images of three primary colors.

On an external side of the display surface, a surface coating may be provided for the purpose of preventing moisture and scratches. Also the substance having a color center may be formed on a surface of a transparent substrate such as a glass plate, and the glass surface may be positioned at the external side thereby achieving prevention of moisture and scratches.

The arrangement may be in a transmission type in which a reproduced light is at the opposite side of the irradiation of the reading light, and a reflective type in which the reproduced light is at the same side of the irradiation of the reading light. Also the hologram erasing unit may be of a type which erases the holographic interference fringes by the function of a light, an electromagnetic wave or heat.

In the following, the present invention will be described in further details. An object of the present invention is to provide a stereo display based on the principle of hologram, without utilizing a master which causes a deterioration in the image quality, and capable of continuously reproducing transmittable images. The present invention relates to a stereo display (continuous hologram reproducing apparatus) namely a reproduction apparatus, but the method of image capture will also be described briefly.

At the image capture, as in the ordinary hologram recording, an object is irradiated with a coherent (interferable) light (wave) and a scattered, reflected or transmitted light is made to interfere with a reference light. A laser light or an electron beam is generally employed for such wave. As it is required, for the purpose of the present invention, to record the interference pattern as a binary or multi-value electric signal, an image pickup device is used for recording the interference pattern. The recording may be executed by directly capturing the interference fringes or by capturing an image thereof focused on a diffusing plate. Otherwise the interference fringes formed as a density pattern on a photosensitive material may be read.

In case of directly capturing the holographic interference fringes, the spectral sensitivity and the linearity to the light intensity of the image pickup device are taken into consideration, as in the ordinary image capture. Since the ordinary image pickup device has a density of several tens of microns per pixel while the interference pattern ordinarily has a density of several microns or less, the interference fringes are projected under magnification, for example by a magnifying lens, and recorded.

In addition to the methods described above, a method not utilizing an actual object may also be used, such as a method of utilizing CHG (computer-generated hologram) data, in which the interference fringes are calculated by a computer graphic technology.

The interference pattern obtained by such known methods is used, after an image processing and a signal transmission, as an ultraviolet laser light deflection signal or an irradiation coordinate signal for the ultraviolet laser and an output modulation signal for the ultraviolet laser, to execute an irradiation on the hologram display surface under a relative scan between the ultraviolet laser light and the position on the hologram display surface and under an intensity modulation. As the scanning method for the ultraviolet laser light, a method of executing a luminance (intensity) modulation of the ultraviolet laser light while executing a scanning thereof along a principal scanning direction X and executing successive displacements along a perpendicular sub-scanning direction Y (raster scanning method) is commonly used.

It is also possible to execute the luminance (intensity) modulation of the ultraviolet laser light, while moving the display surface for causing a relative displacement to the ultraviolet laser light. For the luminance modulation of the ultraviolet laser light, there may be utilized a control (voltage, current, or pulse width) on the input signal to the laser, or a mechanical blanking method such as a galvano mirror or DLP manufactured by TI Inc.

The display surface is characterized in causing a change in physical properties by the ultraviolet laser light and diffracting a light. The resolving power of display is preferably comparative to the wavelength of visible light, namely 20 microns or less, and particularly 1 micron or less. Utilizing an ultraviolet lens of a high NA, the ultraviolet laser light can be condensed to a size of 1 micron or less and may be used for a high-precision scan of a scanner or a stage. A diffraction of light is possible by forming, on the display surface, interference fringes formed by changes in an optical transmittance or in refractive index.

The holograms are classified principally into two types, namely an amplitude type and a phase type. The amplitude type utilizes a silver halide-based film or a photochromic material, and has a theoretical diffraction efficiency of 6.25%. The phase type utilizes bichromate gelatin or a high-molecular liquid crystal, and has a theoretical diffraction efficiency of 34%.

As a substance capable of causing such change in physical properties by the ultraviolet laser light, a substance having a color center is utilized.

The substance having a color center is acted, as described above, by the ultraviolet laser light of a first wavelength to be used for excitation for forming the color center, and the reproducing visible laser light of a second wavelength for irradiation in an excited state thereby causing a diffraction. Then, an excitation light of a third wavelength or a heat is used, when necessary, in the excited state for returning to the ground state. Such third excitation light generally has a longer wavelength than in the reproducing visible laser light. Also in the case that the continuous reproductions have a long cycle time, the erasure can be executed by heating.

The prior television, directly displaying an image on the display surface, has only required a resolving power of display comparable to that of human eyes. In the present invention, the display surface displays holographic interference fringes for diffracting a light, and is thus required to provide a display of a higher resolving power than in the phosphor of the prior cathode ray tube. In the present invention, a display surface, utilizing a substance having a color center, of a display resolving power of about 1 micron is preferred. As the color center is formed, as described above, by a trapping of a single electron in a lattice defect of halogen in the ionic crystal, the display surface utilizing the same has a resolving power theoretically as high as several tens of Angstroms, so that the display resolution of hologram depends on the exposing ultraviolet laser light.

As the ultraviolet laser light, a single-mode laser such as a third harmonic YAG laser (355 nm) or a fourth harmonic YAG laser (266 nm), or a pulsed laser such as a KrF excimer laser (248 nm) or an ArF excimer laser (193 nm) may be utilized. Also usable is a semiconductor laser or a planar light-emission laser of ultraviolet wavelength region, such as based on aluminum nitride, which are currently under development. The ultraviolet laser light can be condensed to a spot size of from 10 to 1 μm or even smaller, by a high NA ultraviolet objective lens.

In the substance having the color center, a portion excited by the ultraviolet laser light and a portion in the ground state are different in a transmittance, a reflectance and a refractive index in specified wavelength regions. It is therefore necessary to consider not only the pitch of the holographic interference fringes but also the wavelength of the visible laser light used as the hologram reproducing light. For example, rubidium chloride has an absorption at about 640 nm, which corresponds to the wavelength of a helium-neon laser.

The change in the transmittance depends on an energy density, a pulse width, a pulse number and a repeating frequency of the ultraviolet laser light, and, in the example of rubidium chloride, the reflectance at 640 nm becomes about 50 to 80% in comparison with the state prior to excitation by the ultraviolet laser light, thus providing a sufficient contrast. Also in the transmittance, a change of about 50 to 80% is observable in comparison with the state prior to excitation by the ultraviolet laser light. Also the refractive index is changed at the same time. Thus, the hologram of the present invention is an amplitude-phase hybrid type and can realize a high diffraction efficiency.

The display surface for hologram reproduction is required, as in the ordinary television, to have a mechanical strength, an impact resistance to the ultraviolet laser light and an environmental stability. As the alkali halides described above include those not high in hardness and those having a high hygroscopic property, it is desirable to apply a surface coating on the alkali halide, or to form the alkali halide on a glass substrate and to position the surface of glass substrate at the external side. The exposure by the ultraviolet laser light is preferably executed from the side of alkali halide.

As the coloration by the ultraviolet laser light is originated from a microscopic ionic crystal structure, the crystal to be employed in the display surface need not be a single crystal or a fused single crystal, but may be polycrystalline or powder. A single crystal structure removes light scattering and provides a transparent display surface in the visible wavelength region, thus being usable as a transmission type.

Also in the case of a reflective hologram reproduction apparatus utilizing diffraction/interference of the laser light reflected from the display surface, the substrate need not be transparent and a substrate of alumina or silicon may be utilized. According to whether the continuous hologram reproducing apparatus is a transmission type or a reflective type, the transparency of the crystal may be controlled by the preparing method or the mono-crystallinity of the substance having color center, constituting the display surface.

In case of a single crystal, the transparency may be improved by a smoothing in a grinding process for forming an optical element. However, a light scattering caused by still remaining surface roughness or by a surface adsorption may become a problem. Also a Fresnel reflection at the surface cannot be avoided for the light incident to an interface between different refractive indexes, and may be observed as a noise light to the diffracted light from the hologram.

In such case, it is desirable to display a hologram not on the surface but on an imaginary plane at a certain constant depth. In order to realize such display, it is desirable, in consideration of the wavelength of the ultraviolet laser light and the bit size of hologram, to execute condensation of light by a lens having an NA of 0.3 or higher and a depth of focus of 10 μm or less.

A hologram can be formed on an imaginary plane of a constant depth, by focusing on the interior of the display plane utilizing such lens and by executing an exposure with the ultraviolet laser light while moving the display surface relative to the ultraviolet laser light.

For forming the crystal on the substrate, usable are a crystallization from a concentrated solution by a solvent evaporation, a formation of fused salt and various solution coating methods. It is also possible to improve the coating property or the adhesion strength to the substrate, by adding polyvinyl alcohol or the like when necessary. Also various additives may be used. Otherwise, a film of a substance having a color center may be formed on a substrate by an evaporation method.

In the case of forming the substance having the color center on the substrate, the substrate can be positioned at the external side (toward the exterior) of the hologram reproduction apparatus whereby the substance having the color center is protected from the mechanical defect or the defect caused by moisture absorption and is directly exposed by the ultraviolet laser light.

Also in case of a color image formation, the absorption wavelengths have to correspond to the three primary colors of R, G and B. For example, lithium bromide or calcium chloride is yellow-colored and absorbs a blue laser light, while potassium chloride or the like is red-colored and absorbs a green laser light, and cesium bromide or the like is blue-colored and absorbs a red laser light. A mixture of these can independently absorb the laser lights of respective wavelengths to cause a change in the transmittance and the reflectance.

In case of mixing three substances having color centers, the substances having three types of color centers are mixed on the surface of the display surface, but each has a small particle size, at least smaller than ⅓ of the beam diameter of the ultraviolet laser light. Therefore, within the beam of the ultraviolet laser light, three substances become colored at the same time.

However, there exists a uniqueness that one substance only satisfies the diffracting condition for the light of a wavelength, among the reproducing visible laser lights of R, G and B. For example in a color display surface of Example 4 to be described later, a laser light of 633 nm is transmitted by the holographic interference fringes of potassium bromide or potassium fluoride, and is absorbed and diffracted only by the holographic interference fringes formed in rubidium chloride.

Also the diffracted light of 633 nm causes an interference only when the pitch of the holographic interference fringes satisfies the interfering condition, thereby providing a reproduced holographic stereo image. In practice, the three substances having the color centers do not have a complete color separating power, and the interfering condition cannot be separated from the resolving power of the ultraviolet laser light, so that an optical noise is generated.

A first object of the present invention is a stereo display, but it is also applicable to a non-stereo display. The holographic interference fringes for stereo display, being Fourier transformed and having a high spatial frequency, cannot be recognized as a meaningful image when directly observed by human eye.

The present invention can also execute a non-stereo display, by expanding the colored portion to a spot size that can be observed directly, by means of the ultraviolet laser light for stereo display.

As already described in the foregoing, alkali halide is colored in itself and is commercialized as a display called a dark trace tube. It is therefore evident that the present invention can be utilized also as a non-stereo display, by expanding the pixel size.

The present invention is characterized in utilizing an ultraviolet laser light instead of the electron beam in the dark trace tube, and in reducing the pixel (dot) size in case of a stereo display. It is also characterized in enlarging the pixel size to a level observable by human eyes in case of a non-stereo display.

As the pixel size recognizable by human eyes is about 2400 dpi in case of a binary display, a pixel size of 10×10 μm or larger can be recognized as an image. Thus a 3D image and a 2D image can be displayed under switching.

Switching of the pixel size may be achieved, for example, by a method of changing the laser output power of the ultraviolet laser light irradiation unit 4 illustrated in FIG. 1, a method of changing a scan speed in writing the holographic interference fringes, or a method of changing an irradiation energy density of the ultraviolet laser light for example by a pulse superposition. In case of switching to a pixel size of 10×10 μm or larger, employable is a method of elevating the laser output power of the ultraviolet laser light irradiation unit 4, reducing the scan speed in writing the holographic interference fringes, or increasing the irradiation energy density of the ultraviolet laser light.

Also a color non-stereo image can be displayed by laminating alkali halide display surfaces corresponding to the three primary colors of R, G and B and by focusing the laser light to one of the laminated display surfaces thereby forming a dot by the coloration of color center, according to non-stereo image data.

In contrast to the dark trace tube, such display is characterized in being free from charge-up phenomenon and not requiring a metal back, because the electron beam is not utilized. Because of a fact that the electron beam has a limited penetration depth and the display surface cannot practically be multiplexed in the direction of thickness, the dark trace tube is limited to a monochromatic display or, in case of a color display, pixel sections formed in plane have to be precisely irradiated by the electron beam.

In the present invention, since each layer can be colored even in a laminated state, a color display can be realized by laminating three coloring layers and executing a pixel selection by addressing the ultraviolet laser light according to (X, Y, Z) coordinates.

In such case, the addressing in the thickness direction is easy as the energy density distribution of the laser light can be selected high within a narrow range by utilizing a lens having a high NA and a limited depth of object field. Also the laser light, being usable in the air in contrast to the electron beam requiring a vacuum system, provides characteristics that the apparatus can be simplified.

The display surface, bearing the holographic interference fringes displayed by the scanning with the ultraviolet laser light as described above, is irradiated over the entire surface by the reproducing visible laser light of a wavelength satisfying the interfering condition. In response, the portion excited and colored by the ultraviolet laser light and the non-excited portion are different in the transmittance and refractive index for the reproducing visible laser light and cause diffraction and interference, thereby providing a reproduced holographic stereo image. In a similar manner as in an ordinary hologram, the diffraction lights from the points of the display surface are re-synthesized in the space to construct a holographic image, thus providing a still stereo image.

The reproduced holographic stereo image may appear above the display surface or below the display surface, depending on a positional relationship between the reproducing visible laser light and the display surface. However, in the case that the light source for the reproducing visible laser light is positioned opposite to the observer with respect to the display surface (in the case that the reproducing light has to transmit the display surface), the display surface is required to be transparent to the reproducing light.

While the prior cathode ray tube uses an opaque scattering member, the substance having a color center can be made transparent and can satisfy the aforementioned necessary condition. Also the substance having the color center of the present invention has a long lifetime of the excited state and can stably maintain the colored state, so that the irradiation by the reproducing visible laser light can be made on the entire surface after the holographic interference fringes of a frame are displayed by the ultraviolet laser light.

It is also possible to reduce the scan time required for a frame, by emitting ultraviolet laser lights, respectively intensity modulated, from plural ultraviolet laser light sources instead of the scan by a single ultraviolet laser light. A planar VCSEL ultraviolet laser is more advantageous as it does not require a scanning operation. A semiconductor-based device as described above is proposed for a multi ultraviolet laser light source.

The substance having a color center may return to the ground state by the reproducing laser light, but such returning is often incomplete. For example, a part of the electrons may be re-trapped in a level, called F′ center. In such case, an irradiation with an incoherent long-wavelength light for erasing can be made over the entire surface. This corresponds to the erasure by a light for a secondary excitation described above.

The erasure can be promoted by heating the display surface to a temperature of several hundred degrees when necessary. The erasing speed shows a dependence on the temperature. For example, in case of potassium bromide crystal, a half life τ is several seconds at the room temperature, 1 second or less at 100° C., and several tens of milliseconds at 500° C.

The stereo image can be observed as a moving image, by repeating these operations at a predetermined repeating period. A longer period results in a flickering of the image, and such period is generally considered as limited to about 1/30 seconds, but in case of a holographic image, such range is not necessarily restrictive.

As will be apparent from the principle of the substance having the color center in the invention, the coloration has an extremely high sensitivity, and the display and the erasure are extremely fast. Photochromic and electrochromic materials are slow in coloration and erasure, as they require energy and time in an ion movement involved in a molecular structural change or a redox reaction. On the other hand, the coloration of the substance having the color center is based on an electron movement as in a semiconductor switching and can achieve a high-speed response. It is also characterized in having an extremely satisfactory repeating durability, as in the semiconductor switching.

A color image display in the hologram reproduction apparatus can be realized by employing a following construction:

At first, prepared is a display device containing first, second and third laminated layers constructed by including an alkali halide or an alkali earth halide of which optical characteristics are changed by a laser light irradiation of a first wavelength region equal to or larger than 190 nm but less than 380 nm.

The first, second and third layers are so made as to have absorption peak wavelengths different with one another in a state where the optical characteristics are changed by the laser light irradiation of the first wavelength region, and the absorption peak wavelengths of the first, second and third layers are respectively made as from 380 to 500 nm, from 500 to 600 nm and from 600 to 800 nm.

A hologram reproduction apparatus is provided by further including a writing unit for writing holographic interference fringes in the display device by the laser light irradiation of the first wavelength region; and

a reproduction unit for reproducing a holographic stereo image by irradiating the display device, in which the holographic interference fringes are written, with a reading light.

As the reading light for the display device in which the holographic interference fringes are written, three reading lights can be employed having peak wavelengths, selected within a second wavelength region of from 380 to 800 nm, respectively from 380 to 500 nm, from 500 to 600 nm and from 600 to 800 nm.

In the invention of the present exemplary embodiment, the display surface is constructed with alkali halide or alkali earth halide, namely a substance having a color center. Therefore a holographic stereo image can be reproduced in continuous manner, by a display surface of which the optical characteristics in the visible region change reversibly by the ultraviolet laser light and in which the characteristics after change are relatively stable and have a long lifetime.

More specifically, holographic interference fringes are formed on such display surface by the ultraviolet laser light, and are used for causing diffraction and interference of the reproducing visible laser light to reproduce a holographic stereo image, and the holographic interference fringes are returned to the ground state, if necessary, by a heat or an infrared laser light irradiation. The holographic stereo images can be reproduced in continuous manner thereafter by repeating the display of holographic interference fringes and the reproduction of holographic stereo image.

### Third Exemplary Embodiment: Volume Hologram

In the following, a volume hologram reproduction apparatus of the present invention will be described. The reproduction of volume hologram of the present invention provides a higher diffraction efficiency and is suitable for realizing a reproduced holographic stereo image of a high image quality and a high contrast.

In case of a volume hologram reproduction, the ultraviolet laser light irradiation unit 4 condenses, as illustrated in FIG. 1, the ultraviolet laser light 2 onto the display surface 1 having the variable optical characteristics. In this state, a luminance modulated irradiation is executed according to digital holographic data under two-dimensional scan to write the holographic interference fringes 3 necessary for the stereo image reproduction. The display surface 1 has a structure similar to that in the hologram reproduction described above, and will not therefore be explained in detail.

The volume hologram is usable not only as an image display apparatus but also as an information record/reproducing apparatus.

A volume hologram means a hologram stereoscopically recorded on a recording medium relatively thick. While the hologram explained in First exemplary embodiment is recorded as a data of f(x,y) on a two-dimensional face, the hologram in the present exemplary embodiment is recorded as a data of f(x,y,z). The volume hologram is thus different from the other hologram in this point.

The reading light irradiation unit irradiates the holographic interference fringes 3, written into the display surface 1, with a reading light 5 of a second wavelength region of from 380 to 800 nm, thereby forming a reproduced holographic stereo image 6.

The reading light irradiation unit usually includes a visible light laser 7, and a magnifying lens 9 for enlarging a visible laser light therefrom thereby irradiating the display surface 1. The reading light irradiation unit may utilize a white-colored light in order to apply a modification to the hologram.

The wavelength of the ultraviolet laser light 2 is same as described for the hologram reproduction, and is 380 nm or less, which is below the wavelengths visible to human, and preferably 360 nm or less that is defined as the ultraviolet region in the international unit system (SI). On the other hand, a wavelength region of 190 nm or less is known as a vacuum ultraviolet region which involves a large absorption loss by the air and requires a lens system of a special material because of the wavelength-refractive index relationship, thereby becoming unable to exploit the advantages of the laser light over an electron beam. In the present invention, therefore, an ultraviolet wavelength region of from 190 to 360 nm is employed advantageously.

In case of volume hologram reproduction, the ultraviolet laser light irradiation unit 4 includes, for example, a lens for condensing the ultraviolet laser light, also an ultraviolet mirror for defining a three-dimensional irradiating position of the ultraviolet laser light, and a galvano mirror or a polygon mirror for executing an XY-scan by the ultraviolet laser light, or by a stage XY-moving unit and a Z-moving unit. An erasing unit 8 may be provided, if necessary, for erasing the interference fringes written on the display surface.

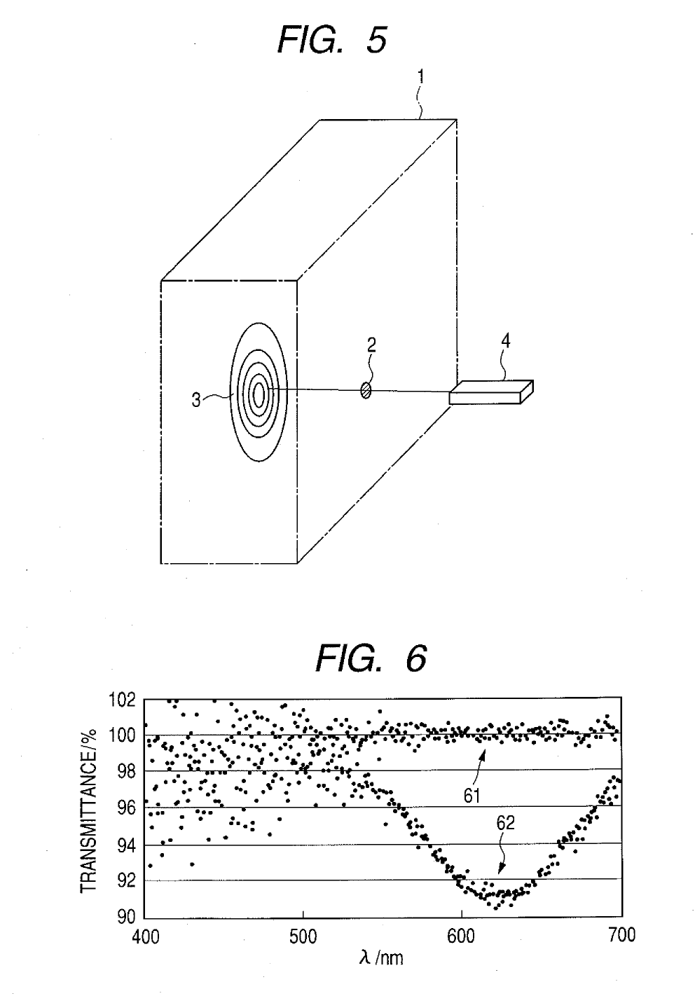

In such structure, the display surface 1 is irradiated as illustrated in FIG. 5 by the ultraviolet laser light 2 from the ultraviolet laser light irradiation unit 4, thereby forming a dot-shaped color center in alkali halide constituting the display surface 1. Then the ultraviolet laser light 2 is luminance modulated under a three-dimensional scan, according to the bit data for digital hologram, thereby constructing holographic interference fringes 3 of a volume hologram, formed by a group of dots. Subsequently the reading light 5 causes a diffraction and an interference by the holographic interference fringes 3 as illustrated in FIG. 3, thereby forming a reproduced holographic stereo image 6.

Further, a continuous reproduction of the holographic stereo images by returning the holographic interference fringes 3 to the ground state by a laser light irradiation or a heating by the erasing unit 8 and repeating the display of the holographic interference fringes and the reproduction of the holographic stereo image.

Materials to be used in the display surface for the volume hologram reproduction of the present invention are as described above, and these materials are collectively called a substance having a color center.

The substance having a color center, not having an optical absorption in the visible wavelength region as described above, is generally colorless and transparent in a single crystal. The substance having a color center becomes colored in a portion irradiated by an ultraviolet laser light, and shows a change in the refractive index at the same time.

Thus, the transmittance and the reflectance is lowered and the refractive index changes at the same time, for a reading light of the wavelength of such coloring or the wavelength of change in the refractive index (for reproduction, a coherent visible laser light is generally used but a white-colored light may also be used: such reading light being hereinafter called “reproducing light” in volume hologram reproduction). A portion not irradiated by the ultraviolet laser light does not show changes in the absorption or in the refractive index in the visible region, thus remaining as transparent or white and having a high transmittance or a high reflectance for the laser light. A reproduced holographic stereo image can be obtained by utilizing this property as a diffraction filter for the reproducing light and by utilizing the holographic interference fringes 3 of an appropriate form.

In the volume hologram reproduction of the present invention, the substance having a color center is irradiated with the ultraviolet laser light to form a pixel bit constructed by a color center, and the substance having a color center and the ultraviolet laser light are moved in a relative manner to form an ordinary two-dimensional hologram. In the volume hologram reproduction of the present invention, in order to further improve the diffraction efficiency, the substance having a color center and the ultraviolet laser light are moved in a three-dimensional space, thereby forming a three-dimensional volume hologram.

Also a reading light irradiation unit which emits reading lights of three wavelengths of R, G and B is used. Also employed is an ultraviolet laser light irradiation unit capable of writing plural holographic interference fringes, involving changes in spectral absorption respectively corresponding to the reading lights of three colors, or involving a change in the refractive index in a specified wavelength region, or involving a difference in the pitch of the holographic interference fringes. In this manner it is possible to simultaneously reproduce hologram images of three primary colors.

In the volume hologram reproduction of the present invention, on an external side of the display surface, a surface coating may be provided for the purpose of preventing moisture and scratches. Also the substance having a color center may be formed on a surface of a transparent substrate such as a glass plate, and the glass surface may be positioned at the external side thereby achieving prevention of moisture and scratches.

The arrangement may be in a transmission type in which the reproduced light is at the opposite side of the irradiation of the reading light, and a reflective type in which the reproduced light is at the same side of the irradiation of the reading light. Also the hologram erasing unit may be of a type which erases the holographic interference fringes by the function of a light, an electromagnetic wave or heat.

The volume hologram reproduction of the present invention is to provide a stereo display based on the principle of hologram as described above, without utilizing a master which causes a deterioration in the image quality, and capable of continuously reproducing transmittable images. The present invention relates to a stereo display (continuous hologram reproducing apparatus), namely a reproduction apparatus, but the method of image capture will also be described briefly.

At the image capture, as in the ordinary hologram recording, an object is irradiated with a coherent (interferable) light (wave) and a scattered, reflected or transmitted light is made to interfere with a reference light. A laser light or an electron beam is generally employed for such wave. In case of a volume hologram, the scattered, reflected or transmitted light from the object and the reference light are introduced respectively from the front and rear sides of a thick photosensitive member for the volume hologram.

As it is required, for the purpose of the present invention, to record the interference pattern as a binary or multi-value electric signal, an image pickup device is used for recording the interference pattern. The recording may be executed by directly capturing the interference fringes or by capturing an image thereof focused on a diffusing plate. Otherwise the interference fringes formed as a density pattern on a photosensitive material may be read.

In case of directly capturing the holographic interference fringes, the spectral sensitivity and the linearity to the light intensity of the image pickup device are taken into consideration, as in the ordinary image capture. Since the ordinary image pickup device has a density of several tens of microns per pixel while the interference pattern ordinarily has a density of several microns or less, the interference fringes are projected under magnification, for example by a magnifying lens, and recorded. Depth information of the volume hologram can be obtained by regulating a focal length of the image capturing system.

In addition to the methods described above, a method not utilizing an actual object may also be used, such as a method of utilizing CHG (computer-generated hologram) data, in which the volume holographic interference fringes are calculated by a computer graphic technology.

The interference pattern obtained by such known methods is used, after an image processing and a signal transmission, as an ultraviolet laser light deflection signal or an irradiation coordinate signal for the ultraviolet laser and an output modulation signal for the ultraviolet laser, to execute an irradiation on the hologram display surface under a relative scan between the ultraviolet laser light and the position on the hologram display surface and under an intensity modulation. As the scanning method for the ultraviolet laser light, a method of executing a luminance (intensity) modulation of the ultraviolet laser light while executing a scanning thereof along a principal scanning direction X and executing successive displacements along a perpendicular sub-scanning direction Y (raster scanning method) is commonly used.

Also a scanning method by a vector scan is also advantageous. For executing a scanning with the ultraviolet laser light, a mechanical scanning unit such as a galvano mirror or a polygon mirror may be employed. The ultraviolet laser light is luminance (intensity) modulated while the display surface and the ultraviolet laser light are displaced in mutual position thereof.

A volume hologram is prepared, in addition to the hologram formation by such two-dimensional scan, by executing a scan also in the depth direction Z. For the luminance modulation of the ultraviolet laser light, there may be utilized a control (voltage, current, or pulse width) on the input signal to the laser, or a mechanical blanking method such as a galvano mirror or DLP manufactured by TI Inc.

The display surface shows a change in the physical properties by the ultraviolet laser light as described above and can diffract the light. The resolving power of display is preferably comparative to the wavelength of visible light, namely 20 microns or less, and particularly 1 micron or less. Utilizing an ultraviolet lens of a high NA, the ultraviolet laser light can be condensed to a size of 1 micron or less and may be used for a high-precision scan of a scanner or a stage.

A diffraction of light is possible by forming, on the display surface, interference fringes formed by changes in an optical transmittance or in refractive index. The holograms are classified principally into two types, namely an amplitude type and a phase type. The amplitude type utilizes a silver halide-based film or a photochromic material, and has a theoretical diffraction efficiency of 6.25%. The phase type utilizes bichromate gelatin or a high-molecular liquid crystal, and has a theoretical diffraction efficiency of 34%. In contrast to these, the volume hologram of the present invention has a theoretical diffraction efficiency of 100%, thus realizing a high diffraction efficiency of 3 to 10 times in comparison with the prior technologies.

A liquid crystal panel or AOM, employed as a digital hologram display medium, is incapable of displaying a volume hologram because of the basic principle thereof. A substance having a color center is used as the substance capable of causing such change in the physical properties by the ultraviolet laser light. The substance having a color center is acted, as described above, by the ultraviolet laser light of a first wavelength to be used for excitation for forming the color center, and the reading light of the second wavelength for irradiation in an excited state thereby causing a diffraction. Also, an excitation light of a third wavelength or a heat is used in the excited state for returning to the ground state. Such third excitation light generally has a longer wavelength than in the reading light. Also in the case that the continuous reproductions have a long cycle time, the erasure can be executed by heating.

In the present invention, the display surface displays holographic interference fringes for diffracting a light, and is thus required to provide a display of a higher resolving power than in the phosphor of the prior cathode ray tube, as described before. In the present invention, a display surface, utilizing a substance having a color center, of a display resolving power of about 1 micron is preferred. As the color center is formed, as described above, by a trapping of a single electron in a lattice defect of halogen in the ionic crystal, the display surface utilizing the same has a resolving power theoretically as high as several tens of Angstroms, so that the display resolution of hologram depends on the exposing ultraviolet laser light.

As the ultraviolet laser light, a single-mode laser such as a third harmonic YAG laser (355 nm) or a fourth harmonic YAG laser (266 nm), or a pulsed laser such as a KrF excimer laser (248 nm) or an ArF excimer laser (193 nm) may be utilized. Also usable is a semiconductor laser or a planar light-emission laser of ultraviolet wavelength region, such as based on aluminum nitride. The single-mode ultraviolet laser light has a high resolving limit because of a short wavelength, and can be condensed to a spot size of from 10 to 1 μm or even smaller, by a high NA ultraviolet objective lens.

In the substance having the color center, a portion excited by the ultraviolet laser light and a portion in the ground state are different in a transmittance, a reflectance and a refractive index in specified wavelength regions. It is therefore necessary to consider not only the pitch of the holographic interference fringes but also the wavelength of the visible laser light used as the hologram reproducing light. For example, rubidium chloride has an absorption at about 640 nm, which corresponds to the wavelength of a helium-neon laser.

The change in the transmittance depends on an energy density, a pulse width, a pulse number and a repeating frequency of the ultraviolet laser light, and, in the example of rubidium chloride, the reflectance at 640 nm becomes about 50 to 80% in comparison with the state prior to excitation by the ultraviolet laser light, thus providing a sufficient contrast. Also in the transmittance, a change of about 50 to 80% is observable in comparison with the state prior to excitation by the ultraviolet laser light. Also the refractive index is changed at the same time. Thus, the hologram of the present invention is an amplitude-phase hybrid type and can realize a high diffraction efficiency.

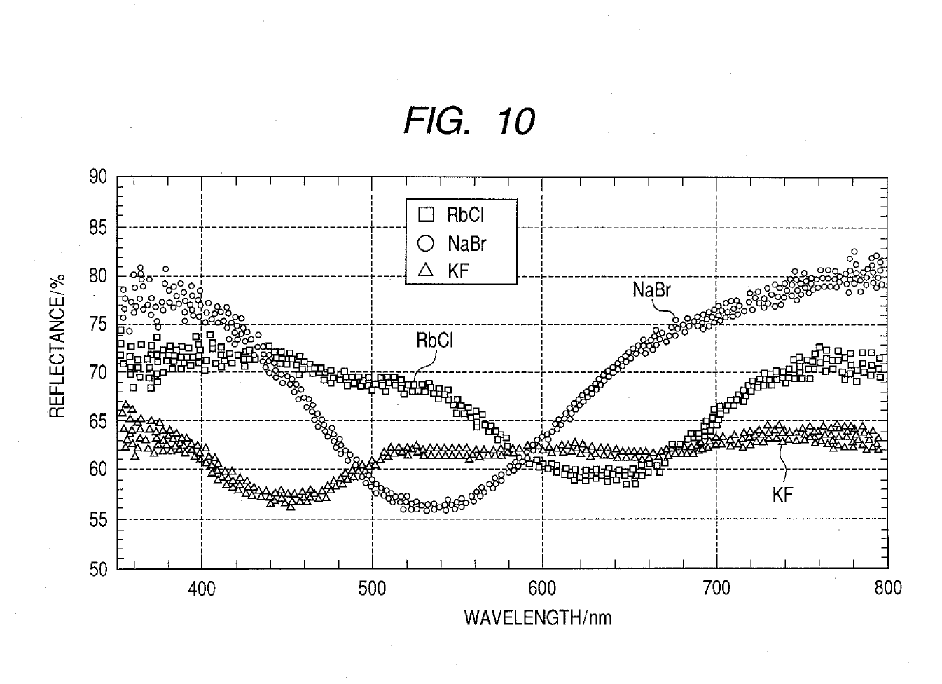

Rubidium chloride has an absorption wavelength at about 640 nm, while sodium bromide at about 540 nm, and potassium fluoride at about 450 nm. The present inventors prepared a volume hologram recording medium by working each of these three single crystals into a thickness of 1=and by laminating the mirror-finished surfaces. FIG. 10 illustrates the respective reflective spectra after irradiation with the ultraviolet laser light.

The lamination was made in the order of rubidium chloride, sodium bromide and potassium fluoride, from the side of the ultraviolet laser light. However, the lamination need not necessarily be in this order. As an example of the writing pitch, holographic interference fringes were written with respectively different pitches into the volume hologram recording medium (an example of writing being described in Example 7 to be described later)

A YAG laser light of 266 nm was condensed so as to be focused in the rubidium chloride layer, and step scanned at a predetermined pitch in the planar direction (X and Y) and in the thickness direction (Z) of the layer and the laser light was turned on and off according to CGH (computer-generated hologram) data, thereby writing a binary hologram. The step pitch in this operation was selected as 13 μm.

Similarly the light was condensed so as to be focused in the sodium bromide layer, and step scanned with a pitch of 11 μm in the planar direction (X and Y) and in the thickness direction (Z) of the layer, thereby writing a hologram. Similarly the light was condensed so as to be focused in the potassium fluoride layer, and step scanned with a pitch of 9 μm in the planar direction (X and Y) and in the thickness direction (Z) of the layer, thereby writing a hologram.

Then the volume hologram was irradiated by reading lights of three wavelengths, including a blue color having a peak wavelength of from 380 to 500 nm, a green color having a peak wavelength of from 500 to 600 nm, and a red color having a peak wavelength of from 600 to 800 nm.

The blue laser having a peak wavelength of from 380 to 500 nm can be, for example, argon laser (488 nm), He—Cd laser (441.6 nm), gallium nitride laser diode (400-500 nm) or SHG of infrared semiconductor laser (425 or 410 nm).

The green laser having a peak wavelength of from 500 to 600 nm can be selected from YAG-SHG laser (532 nm) and argon laser (514.5 nm). The red laser having a peak wavelength of from 600 to 800 nm can be selected from He—Ne laser (633 nm), AlGaInP type laser diode (630-680 nm) and krypton laser (647 nm).

Then potassium bromide (absorption wavelength at about 630 nm) was employed as a volume hologram recording medium, and a hologram was written with a pitch of 12 μm by a similar method. The writing was executed at the temperature of liquid nitrogen, and, after the reproduction of hologram, it was heated to 100° C. to erase the hologram. In addition to heating by a heater, any heating method may be utilized such as a far infrared light (wavelength of 800 nm or larger) of a carbon dioxide laser (10.6 μm).

The erasure of holographic interference fringes has been described by an example of the volume hologram recording medium utilizing potassium bromide, but a similar method is applicable in the case of a volume hologram recording medium of laminated rubidium chloride, sodium bromide and potassium fluoride. Also the writing can be in the same manner as described above.

As a lens for condensing the laser light of the first wavelength region (equal to or larger than 190 nm but less than 380 nm), for example Mitsutoyo UXx50 (NA 0.4) can be used. With a smaller NA value, the intensity ratio in the Z-axis direction becomes small (condensing rate becoming small), whereby the writing in a specified Z-axis position of the volume hologram recording medium becomes difficult.

The display surface for volume hologram reproduction of the present invention is required, as in the ordinary television, to have a mechanical strength, an impact resistance to the ultraviolet laser light and an environmental stability. As the alkali halides described above include those not high in hardness and those having a high hygroscopic property, it is desirable to apply a surface coating on the alkali halide, or to form the alkali halide on a glass substrate and to position the surface of glass substrate at the external side. The exposure by the ultraviolet laser light is preferably executed from the side of alkali halide.

As the coloration by the ultraviolet laser light is originated from a microscopic ionic crystal structure, the crystal to be employed in the display surface need not be a single crystal or a fused single crystal, but may be polycrystalline or powder. A single crystal structure removes light scattering and provides a transparent display surface in the visible wavelength region, thus being usable as a transmission type.

Also in the case of a reflective hologram reproduction apparatus utilizing diffraction/interference of the laser light reflected from the display surface, the substrate for the substance having the color center need not be transparent and a substrate of alumina or silicon may be utilized. According to whether the continuous hologram reproducing apparatus is a transmission type or a reflective type, the transparency of the crystal may be controlled by the preparing method or the mono-crystallinity of the substance having color center, constituting the display surface.

In case of a single crystal, the transparency may be improved by a smoothing in a grinding process for forming an optical element. The hologram is formed on an imaginary plane of a constant depth from the surface of the single crystal, and then holograms are formed by moving the depth at a predetermined pitch thereby finally forming a volume hologram.

In order to realize such form, it is desirable, in consideration of the wavelength of the ultraviolet laser light and the bit size of hologram, to execute condensation of light by a lens having an NA of 0.3 or higher and a depth of focus of 10 μm or less. A hologram can be formed on an imaginary plane of a constant depth, by focusing on the interior of the display plane utilizing such lens and by executing an exposure with the ultraviolet laser light while moving the display surface relative to the ultraviolet laser light.

For forming the crystal on the substrate, usable are a crystallization from a concentrated solution by a solvent evaporation, a formation of fused salt and various solution coating methods. It is also possible to improve the coating property or the adhesion strength to the substrate, by adding polyvinyl alcohol or the like when necessary. Also various additives may be used. Otherwise, a film of a substance having a color center may be formed on a substrate by an evaporation method.

In the case of forming the substance having the color center on the substrate, the substrate can be positioned at the external side (toward the exterior) of the hologram reproduction apparatus whereby the substance having the color center is protected from the mechanical defect or the defect caused by moisture absorption. At the same time, it is preferably exposed directly by the ultraviolet laser light.

In case of reproduction of the volume hologram of the present invention, the display surface, bearing the holographic interference fringes displayed by the scanning with the ultraviolet laser light as described above, is irradiated over the entire surface by the reading light of a wavelength satisfying the interfering condition. In response, the portion excited and colored by the ultraviolet laser light and the non-excited portion are different in the transmittance and refractive index for the reading light and cause diffraction and interference, thereby providing a reproduced holographic stereo image. In a similar manner as in an ordinary hologram, the diffraction lights from the points of the display surface are re-synthesized in the space to construct a holographic image, thus providing a still stereo image.

The reproduced holographic stereo image may appear above the display surface or below the display surface, depending on a positional relationship between the reading light and the display surface. However, in the case that the light source for the reading light is positioned opposite to the observer with respect to the display surface (in the case that the reproduced light has to transmit the display surface), the display surface is required to be transparent to such reading light.

While the prior cathode ray tube uses an opaque scattering member, the substance having a color center can be made transparent and can satisfy the aforementioned necessary condition. Also the substance having the color center of the present invention has a long lifetime of the excited state at the room temperature and can stably maintain the colored state, so that the irradiation by the reading light can be made on the entire surface after the holographic interference fringes of a frame are displayed by the ultraviolet laser light.

It is also possible, as described before, to reduce the scan time required for a frame, by emitting ultraviolet laser lights, respectively intensity modulated, from plural ultraviolet laser light sources instead of the scan by a single ultraviolet laser light. A planar VCSEL ultraviolet laser is more advantageous as it does not require a scanning operation. A semiconductor-based device as described above is proposed for a multi ultraviolet laser light source.

The substance having a color center may return to the ground state by the reading laser light, but such returning is often incomplete. For example, a part of the electrons may be re-trapped in a level, called F′ center. In such case, an irradiation with an incoherent long-wavelength light for erasing can be made over the entire surface. This corresponds to the erasure by a light for a secondary excitation described above.

The erasure can be promoted by heating the display surface to a temperature of several hundred degrees when necessary. The erasing speed shows a dependence on the temperature. For example, in case of potassium bromide crystal, a half life τ is several seconds at the room temperature, 1 second or less at 100° C., and several tens of milliseconds at 500° C.

The stereo image can be observed as a moving image, by repeating these operations at a predetermined repeating period. A longer period results in a flickering of the image, and such period is generally considered as limited to about 1/30 seconds.

As will be apparent from the principle of the substance having the color center in the invention, the coloration has a high sensitivity, and the display and the erasure are fast. In comparison with photochromic and electrochromic materials, which require energy and time in an ion movement involved in a molecular structural change or a redox reaction, the coloration of the substance having the color center is based on an electron movement as in a semiconductor switching and can achieve a high-speed response. Also the repeating durability is satisfactory, as in the semiconductor switching.

The holograms of the present invention, described in the exemplary embodiments 1 to 3, may be utilized not only as a display for showing characters or images, but also as an information recording/reproducing apparatus. Such apparatus for example include a hologram data-encoding unit, a hologram-recording unit, a hologram-reading and reproduction unit, and a hologram data decoding unit.

### EXAMPLES

In the following, examples of the present invention will be described.

### Example 1

Example 1 employed, as alkali halide constituting the display surface, a potassium bromide single crystal for infrared optical crystal, having a circular size of 30 mmφ, and a thickness of 3 mm. A hologram was written on a cleavage surface (100). FIG. 6 illustrates transmission spectra of the potassium bromide employed in the display surface, before and after the irradiation with ultraviolet laser light.

As the ultraviolet laser for hologram writing, a pulsed laser HIPPO-355Q (third harmonic YAG 355 nm) manufactured by Spectra Physics Inc. was used and oscillated with a frequency of 40 kHz. It had an oval spot of 2.5 mm×3.5 mm. A power applied to DPSS (diode pumping) was so regulated as to obtain an energy of 0.54 μJ per pulse.

The light was condensed by Mitsutoyo MPlun UV50x into a spot of 1.13×0.89 μm on the display surface. Dots were written by fixing the display surface on an XY-stage and scanning a width of 10 mm at a speed of 1 mm/sec and with a main scanning direction taken at the direction of the longer axis. As the ultraviolet laser light has a repeating frequency of 40 kHz, 40 dots are written within 1 μm under positional displacements and under overlapping. The direction of shorter axis was taken as the sub scanning direction, and 200 lines of a line-and-space pattern of about 1 μm and 9 μm were drawn by 100 reciprocating cycles of the main scanning with a pitch of 10 μm.

On thus drawn diffraction grating (one type of interference fringes), a light of a helium-neon laser (wavelength: 633 nm, spot diameter: 2 mm) was perpendicularly introduced as a reading visible light. The diffraction spots were observed to 5th order or higher, with a diffraction intensity of 10% or higher at the peak time, but it was observed that the diffraction grating vanished in about 20 seconds to gradually weaken the diffraction intensity to a state where a 0th order light alone was observed and the diffraction was no longer observed.

It was also found, by an exposure experiment with a non-condensed ultraviolet laser light, in the color center forming portion of the display surface of the present example, that the optical absorption spectrum had a broad absorption band spreading about from 500 to 700 nm and an absorption peak at about 630 nm. In the present example, a verification was made with a diffraction grating in order to clarify the basic physical properties of hologram.

### Example 2

Example 2 employed, as alkali halide constituting the display surface, a potassium bromide single crystal for infrared optical crystal, having a circular size of 30 mmφ, and a thickness of 3 mm. A hologram was written on a cleavage surface (100).

As the ultraviolet laser for hologram writing, a pulsed laser HIPPO-266Q (fourth harmonic YAG 266 nm) manufactured by Spectra Physics Inc. was used and oscillated with a frequency of 40 kHz. It had an oval spot of 2.2 mm×3.3 mm. A power applied to DPSS (diode pumping) was so regulated as to obtain an energy of 0.21 μJ per pulse.

The light was condensed by Mitsutoyo MPlun UV50x into a spot of 0.95×0.66 μm on the display surface.

A group of dots was written by fixing the display surface on an XY-stage and scanning a width of 10 mm at a speed of 1 mm/sec and with a main scanning direction taken at the direction of the longer axis. As the ultraviolet laser light has a repeating frequency of 40 kHz, 40 dots are written within 1 μm under positional displacements and under overlapping. The direction of shorter axis was taken as the sub scanning direction, and 200 lines of a line-and-space pattern of about 1 μm and 9 μm were drawn by 100 reciprocating cycles of the main scanning with a pitch of 10 μm.

On thus drawn diffraction grating (one type of interference fringes), a light of a helium-neon laser (wavelength: 633 nm, spot diameter: 2 mm) was perpendicularly introduced as a reading visible light. The diffraction spots were observed to 5th order or higher, with a diffraction intensity of 10% or higher at the peak time. It was found that, in case of writing on potassium bromide with the ultraviolet laser light 266 nm, the time to erasure was extended to several hours. In the present example, a verification was made with a diffraction grating in order to clarify the basic physical properties of hologram.

### Example 3

As in Example 2, a diffraction grating was formed with an ultraviolet laser light, and the diffraction spots were reproduced by a helium-neon laser. Thereafter, when it was blown by a hot air of 300° C., it was found that the diffraction grating vanished in about 10 seconds to gradually weaken the diffraction intensity, to a state where a 0th order light alone was observed and the diffraction was no longer observed.

Also by controlling the temperature of the display surface at 300° C. from the beginning, the diffraction grating vanished within 1 second. The vanishing speed of color center, being considered to have a temperature dependence, was confirmed to have a time constant within a practical level.

As a result of intensive investigation undertaken by the present inventor, it was confirmed, by another experiment utilizing a non-condensed ultraviolet laser light, that the formation of color center does not have a temperature dependence. Therefore, when the temperature of the display surface was controlled at 300° C. from the beginning, the diffraction peak intensity remained unchanged at 15% but vanished within 1 second, thus indicating a possibility as a moving image hologram.

Also, in the case of utilizing a ultraviolet laser light of 355 nm in Example 1, the diffraction grating vanished within 1 second by elevating the temperature merely to 100° C., and, at an even higher temperature, the diffraction spots were only instantaneously confirmed and were difficult to measure.

### Example 4

In the process of Example 2, the ultraviolet laser light was luminance modulated according to data of a computer-generated hologram instead of the diffraction grating, under a scanning, to write holographic interference fringes on the display surface. On thus drawn holographic interference fringes, a light of a helium-neon laser (wavelength: 633 nm, spot diameter: 2 mm) was perpendicularly introduced to reproduce a stereo still image.

### Example 5

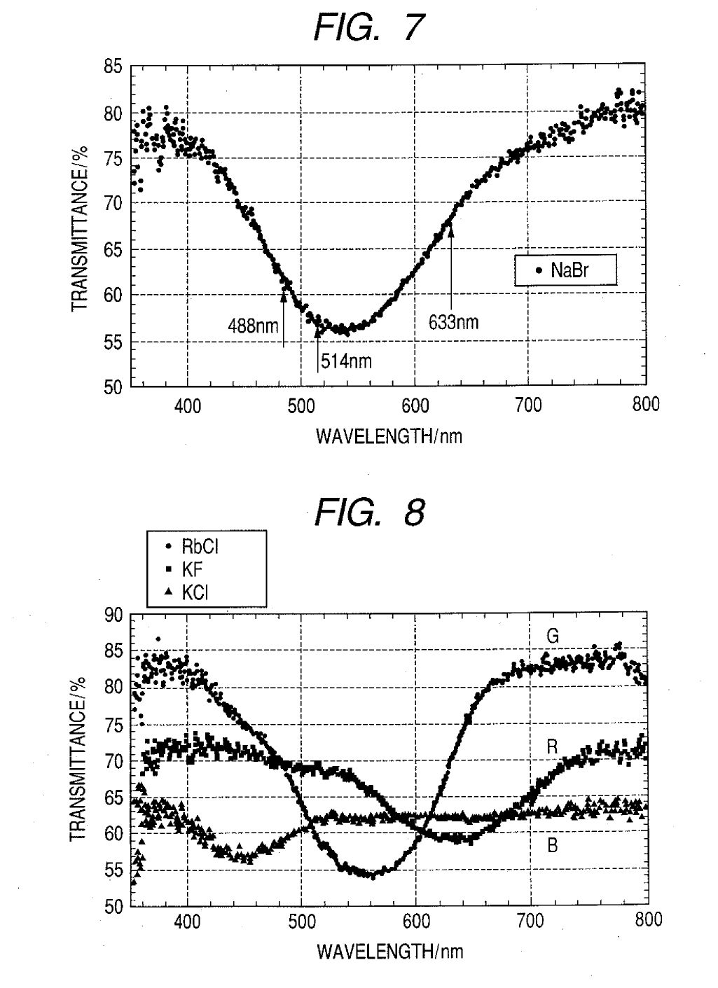

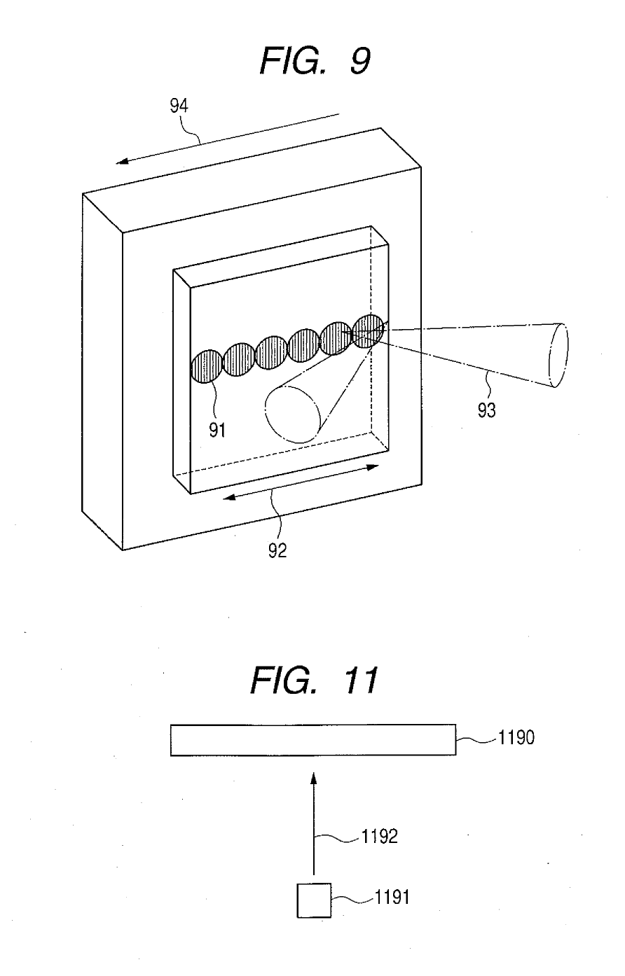

Example 5 employed a (100) plane of NaBr (sodium bromide) as the display surface. FIG. 7 illustrates a transmission spectrum of the display surface after irradiation with an ultraviolet laser light. Three holographic interference fringes were synthesized with pitches thereof corresponding not only to the wavelength 633 nm of the helium-neon laser but also to the wavelengths 514 and 488 nm of argon lasers. Then, an ultraviolet laser light was converged to a spot size of 0.95×0.66 μm and executed a scan according to the shape of the synthesized holographic interference fringes thereby displaying holographic interference fringes.

The scan, executed at a pitch of 10 μm in Examples 1 and 2, was executed in the present example with a pitch of 1 μm.

Then reproducing visible lights of 633, 514 and 488 nm were expanded by a lens and collectively irradiated. Sodium bromide, having an absorption in a relatively wide wavelength range, shows changes in the transmittance and in the refractive index at the wavelengths of these three laser lights, whereby a color hologram was reproduced.

### Example 6

Example 6 prepared a hologram in a deeper side of the display surface. The lens Mitsutoyo MPlun UV50x employed in Example 2 has an operation distance of 12 mm and a focal distance of 4 mm. In the configuration of Example 2, the lens Mitsutoyo MPlun UV50x was moved in the Z-axis direction (laminating direction of the crystal) for focusing at a position of 100 μm from the display surface.

The light was condensed to a spot size of 0.95×0.66 μm. A hologram was formed on an XY two-dimensional imaginary plane at this focal position. This imaginary plane is also a (100) plane, like the cleaved surface. When a diffraction grating as in Example 2 was formed, the diffraction efficiency for the He—Ne laser light was improved to 15%.

### Example 7

In Example 7, a display surface was formed by slicing and polishing three crystals of rubidium chloride (for 633 nm), potassium chloride (for 514 nm) and potassium fluoride (for 488 nm) each into a thickness of 1 mm, as the substances having the color center, and laminating and adhering these crystals in this order. FIG. 8 illustrates transmission spectra of the crystals after irradiation with the ultraviolet laser light.

The laminated display surfaces are laminated as indicated below, with respect to the state where the optical characteristics are changed by the laser light irradiation. Lamination can be made with the display surfaces of alkali halide or alkali earth halide of three types, respectively having absorption peak wavelengths of from 380 to 500 nm, from 500 to 600 nm and from 600 to 800 nm.

The lens Mitsutoyo MPlun UV50x employed in Example 2 has an operation distance of 12 mm and a focal distance of 4 mm. This lens was moved in the Z-axis direction (laminating direction of the crystal) for focusing at a depth of 100 μm from the surface of rubidium chloride constituting one of the display surfaces. The light was condensed to a spot size of 0.95×0.66 μm. By the scanning with the ultraviolet laser light based on the aforementioned holographic data, holographic interference fringes for R color were formed with a pitch (dot interval) of 3 μm.

Similarly, holographic interference fringes were formed for G color with a pitch of 2 μm, at a depth of 100 μm from the surface of potassium chloride, and, for B color, with a pitch of 1 μm at a depth of 100 μm from the surface of potassium fluoride. (The ultraviolet laser light had a wavelength region equal to or larger than 190 nm but less than 380 nm as described above.)

Then reproducing visible lights of 633, 514 and 488 nm were expanded by a lens and collectively irradiated. The reproducing visible lights were diffracted and caused interference by the holographic interference fringes having changes in refractive index and absorption in respective wavelengths, whereby a color hologram was reproduced.

As the reproducing visible lights, reading lights having wavelengths of three colors can be used, including a blue light having a peak wavelength of from 380 to 500 nm, a green light having a peak wavelength of from 500 to 600 nm, and a red light having a peak wavelength of from 600 to 800 nm.

### Example 8

In the configuration of Example 7, the scanning was made with a pitch of 1 μm for all of R, G and B, while a pixel size was selected as 20×20 μm, and a pixel dot size was modulated in 16 levels according to non-stereo bit map data, thereby displaying a non-stereo image.

### Example 9

Examples 9 to 11 relate to a volume hologram reproduction. As alkali halide constituting the display surface, a potassium bromide single crystal for infrared optical crystal, having a circular size of 30 mmφand a thickness of 3 mm, was employed. A hologram was written on a cleavage surface (100).

As the ultraviolet laser for hologram writing, a pulsed laser HIPPO-266Q (fourth harmonic YAG 266 nm) manufactured by Spectra Physics Inc. was used and oscillated with a frequency of 40 kHz. It had an oval spot of 2.2 mm×3.3 mm. A power applied to DPSS (diode pumping) was so regulated as to obtain an energy of 0.21 μJ per pulse.

The light was condensed by Mitsutoyo MPlun UV50x into a spot of 0.95×0.66 μm at a depth of 2 mm from the display surface.

A hologram was formed on an XY two-dimensional imaginary plane at this focal position. This imaginary plane is also a (100) plane, like the cleaved surface.

A group of dots was written by fixing the display surface on an XY-stage and scanning a width of 10 mm at a speed of 1 mm/sec and with a main scanning direction taken at the direction of the longer axis. As the ultraviolet laser light has a repeating frequency of 40 kHz, 40 dots are written within 1 μm under positional displacements and under overlapping. The direction of shorter axis was taken as the sub scanning direction, and 200 lines of a line-and-space pattern of about 1 μm and 9 μm were drawn by 100 reciprocating cycles of the main scanning with a pitch of 10 μm.

On thus drawn diffraction grating (one type of interference fringes), a light of a helium-neon laser (wavelength: 633 nm, spot diameter: 2 mm) was perpendicularly introduced as a reading visible light. The diffraction spots were observed to 5th order or higher, with a diffraction intensity of 10% or higher.

Further, the display surface was moved by the Z-axis stage in the direction of depth with a pitch of 10 μm, thereby obtaining a volume hologram in which the diffraction gratings formed by the above-described XY-scan exposure were multiplexed by 100 times in the depth direction.

The diffraction intensity of the volume hologram of the present invention on the perpendicular incident light of the helium-neon laser (wavelength: 633 nm, spot size: 2 mm) was improved to 30% or higher. It was thus clarified that the volume hologram had a diffraction efficiency higher than that in the two-dimensional hologram. In the present example, a verification was made with a diffraction grating in order to clarify the basic physical properties of hologram.

### Example 10

In the process of Example 9, a diffraction grating was formed by the ultraviolet laser light while controlling the temperature of a volume hologram display medium at 100° C. and diffraction spots were simultaneously reproduced by a helium-neon laser. It was observed that the diffraction grating vanished in about 30 seconds to gradually weaken the diffraction intensity to a state where a 0th order light alone was observed and the diffraction was no longer observed.

As a result of intensive investigation undertaken by the present inventor, it was confirmed, by another experiment utilizing a non-condensed ultraviolet laser light, that the formation of color center does not have a temperature dependence while the vanishing of the color center has a temperature dependence. Therefore, when the temperature of a volume hologram display medium was controlled at 100° C. from the beginning, the diffraction peak intensity remained unchanged at 30% but vanished within 30 second, thus indicating a possibility as a moving image hologram.

### Example 11, Hologram

In the process of Example 9, the ultraviolet laser light was luminance modulated according to data of a computer-generated hologram instead of the diffraction grating, under a scanning, to write holographic interference fringes. On thus drawn holographic interference fringes, a light of a helium-neon laser (wavelength: 633 nm, spot diameter: 2 mm) was perpendicularly introduced to reproduce a stereo still image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2006-064236, filed Mar. 9, 2006 and No. 2006-229234, filed Aug. 25, 2006, which are hereby incorporated by reference herein in their entirety.

What is claimed is:

1. A display apparatus comprising:
a display device including a layer constructed by including an alkali halide or an alkali earth halide of which optical characteristics are changed by a laser light irradiation of a first wavelength region equal to or larger than 190 nm but less than 380 nm;
a first light source for emitting a laser light of the first wavelength region, in order to write display data in the display device; and
a second light source for irradiating the display device in which the display data are written, with a light of a second wavelength region of from 380 to 800 nm.

2. The display apparatus according to claim 1, wherein the display device comprises the layer in plural units, containing materials having light absorption peak wavelengths which are different each other.

3. The display apparatus according to claim 1, wherein the first light source and the second light source include a single light source variable in wavelength.

4. The display apparatus according to claim 1, wherein the display data are holographic data.

5. A hologram reproduction apparatus comprising:
a display device constructed by including an alkali halide or an alkali earth halide of which optical characteristics are changed by a laser light irradiation of a first wavelength region equal to or larger than 190 nm but less than 380 nm;
a writing unit which writes holographic interference fringes in the display device, by a laser light irradiation of the first wavelength region; and
a unit which irradiates the holographic interference fringes with a reading light of a second wavelength region of from 380 to 800 nm thereby reproducing a holographic stereo image.

6. The hologram reproduction apparatus according to claim 5, wherein the holographic interference fringes are written as dot data based on holographic data in the display device.

7. The hologram reproduction apparatus according to claim 5, further comprising:
an erasing unit for erasing the holographic interference fringes;
wherein a continuous reproduction of holographic stereo images is executed by repeating the writing of the holographic interference fringes by the writing unit, the reproduction of the holographic stereo image by the reproduction unit, and the erasure of the holographic interference fringes by the erasing unit.

8. The hologram reproduction apparatus according to claim 7, wherein the erasing unit erases the holographic interference fringes by an action of a laser light irradiation, an electromagnetic wave or a heat.

9. The hologram reproduction apparatus according to claim 8, wherein the laser light irradiation has a wavelength equal to or larger than 700 nm.

10. The hologram reproduction apparatus according to claim 5, wherein the irradiation of the reading light of the second wavelength region is executed from a same side as the laser light irradiation of the first wavelength region to the display device.

11. The hologram reproduction apparatus according to claim 5, wherein the writing unit forms the holographic interference fringes on an imaginary plane defined in a direction of depth of the display device.

12. The hologram reproduction apparatus according to claim 5, wherein a stereo display and a non-stereo display are switched by switching a pixel size in the dot data.

13. A hologram reproduction apparatus comprising:
a display device containing first, second and third laminated layers constructed by including an alkali halide or an alkali earth halide of which optical characteristics are changed by a laser light irradiation of a first wavelength region equal to or larger than 190 nm but less than 380 nm;
wherein the first, second and third layers have absorption peak wavelengths different with one another in a state where the optical characteristics are changed by the laser light irradiation of the first wavelength region;
wherein the absorption peak wavelengths of the first, second and third layers are respectively from 380 to 500 nm, from 500 to 600 nm and from 600 to 800 nm;
a writing unit for writing holographic interference fringes in the display device by the laser light irradiation of the first wavelength region; and
a reproduction unit for reproducing a holographic stereo image by irradiating the display device, in which the holographic interference fringes are written, with a reading light.

14. The hologram reproduction apparatus according to claim 13, wherein the holographic interference fringes are written as dot data based on holographic data in the display device.

15. The hologram reproduction apparatus according to claim 13, wherein three reading lights respectively having a peak wavelength, selected within a second wavelength region of from 380 to 800 nm, of from 380 to 500 nm, a peak wavelength of from 500 to 600 nm and a peak wavelength of from 600 to 800 nm are used on the display device in which the holographic interference fringes are written, to reproduce a holographic stereo image.

16. The hologram reproduction apparatus according to claim 13, further comprising:
an erasing unit for erasing the holographic interference fringes;
wherein a continuous reproduction of holographic stereo images is executed by repeating the writing of the holographic interference fringes by the writing unit, the reproduction of the holographic stereo image by the reproduction unit, and the erasure of the holographic interference fringes by the erasing unit.

17. The hologram reproduction apparatus according to claim 16, wherein the erasing unit erases the holographic interference fringes by an action of a laser light irradiation, an electromagnetic wave or a heat.

18. The hologram reproduction apparatus according to claim 17, wherein the laser light irradiation has a wavelength equal to or larger than 700 nm.

19. The hologram reproduction apparatus according to claim 13, wherein a stereo display and a non-stereo display are switched by switching a pixel size in the dot data.

20. An apparatus utilizing a hologram comprising:
a volume hologram recording medium constructed by including an alkali halide or an alkali earth halide of which optical characteristics are changed by a laser light irradiation of a first wavelength region equal to or larger than 190 nm but less than 380 nm;
a first light source for irradiating the volume hologram recording medium with a laser light of the first wavelength region; and
a second light source for irradiating the volume hologram recording medium with a light of a second wavelength region of from 380 to 800 nm;
wherein the volume hologram recording medium and the first light source are moved in a relative three-dimensional scan to form, on the volume hologram recording medium, volume holographic interference fringes based on bit data.

21. The apparatus utilizing the hologram according to claim 20, wherein the volume hologram recording medium includes plural layers containing an alkali halide or an alkali earth halide, and the plural layers are changed in the optical characteristics by a laser light irradiation of the first wavelength region and have respectively different absorption peak wavelengths in a state where the optical characteristics are changed.
